(19) United States
(12) Patent Application Publication
(10) Pub. No.: US 2012/0088077 A1
(43) Pub. Date: Apr. 12, 2012

(54) INJECTION PREFORM HAVING PATTERN ON SURFACE THEREOF AND METHOD OF MANUFACTURING THE SAME

(75) Inventors: Hyun-Jung JUNG, Seoul (KR); Chang-Youn HWANG, Gyeonggi-do (KR); Hoon-Soo PARK, Gyeonggi-do (KR); Jung-Hyeon KIM, Gyeonggi-do (KR)

(73) Assignee: SAMSUNG ELECTRONICS CO., LTD., Gyeonggi-Do (KR)

(21) Appl. No.: 13/239,928

(22) Filed: Sep. 22, 2011

(30) Foreign Application Priority Data
Oct. 11, 2010 (KR) 10-2010-0098863

(51) Int. Cl. B32B 3/10; B05D 5/02; B32B 27/00

(52) U.S. Cl. 428/203; 428/201; 427/258

(57) ABSTRACT

An injection preform having a pattern on a surface thereof and realizing a transparent pattern paint layer for forming a crack pattern in a transparent or semi-transparent substrate, and a method of manufacturing the same. The injection preform preferably includes: a substrate injection molded so as to be transparent or semi-transparent; a primer layer painted on a rear surface of the substrate; a transparent pattern paint layer painted on a rear surface of the primer layer, a surface of the transparent pattern paint layer being dried with hot air in an oven such that a pattern is formed; a deposition layer deposited on a rear surface of the transparent pattern paint layer; a finishing layer painted on a rear surface of the deposition layer; and a clear coating layer painted on a front surface of the substrate.

### CLAIM OF PRIORITY

This application claims the benefit of priority under 35 U.S.C. §119(a) from an application entitled “Injection Preform Having Pattern On Surface Thereof And Method Of Manufacturing The Same” filed in the Korean Intellectual Property Office on Oct. 11, 2010 and assigned Serial No. 10-2010-0098863, the contents of which are hereby incorporated by reference in its entirety.

### BACKGROUND OF THE INVENTION

1. Field of the Invention

The present invention relates to an injection preform having a pattern on a surface thereof. More particularly, the present invention relates to a preform that includes a transparent pattern paint layer for forming a crack pattern in a transparent or semi-transparent substrate, and a method of manufacturing the same.

2. Description of the Related Art

In general, the number of plastic molded products that are in use continues to increase in various fields, including but not limited to cosmetic cases, information communication devices, cases and windows for electronic devices, vehicles, and electronic equipment, etc., just to name a few possibilities.

The durability and hardness of an outer surface of such a product is lower than those of glass or metals, causing its product value to be lost. Various painting techniques have been developed to protect outer surfaces of plastic molded products from being damaged and to improve hardness and gloss. The most commonly used painting techniques include a natural drying method, a low-temperature bake method, an ultraviolet ray hardening method, etc.

Also, conventional methods for processing outer surfaces of plastic molded products to provide colors and metallic feelings generally include common painting techniques such as dipping, spraying, and spindling using organic and inorganic materials, a thin film coating method using a metal, and a sealing method.

As illustrated in FIG. 1, a conventional method 1 of processing an outer surface of a plastic molded product includes the steps of: depositing a primer layer 3 on a plastic molded product 2, depositing a color paint layer 4, depositing a base coating layer 5, and a clear coating layer 6.

However, according to the conventional method of processing an outer surface of a plastic molded product as shown in FIG. 1, various color paint layers desired by a user may be selected and deposited on a plastic molded product, various patterns (for example, crack patterns) with various colors and metallic feelings cannot be formed, making it difficult to make designs of products appealing.

As such, it is difficult to realize a crack pattern on an outer surface of a conventional plastic product with a mold.

Therefore, there is a long-felt need in the art to form a crack pattern on an outer surface of a plastic molded product easily in order to realize a design of luxurious patterns (for example, for ceramics, marbles, and exterior building materials).

### SUMMARY OF THE INVENTION

Accordingly, the present invention provides an injection preform that includes a transparent pattern paint layer manufactured to form a crack pattern in a transparent or semi-transparent substrate, realizing patterns (for example, rough patterns, block patterns, etc.) for ceramics, marbles, and exterior building materials and making designs of products appealing.

In accordance with an exemplary aspect of the present invention, there is provided an injection preform having a pattern on a surface thereof, the injection preform preferably including: a substrate injection molded so as to be transparent or semi-transparent; a primer layer painted on a rear (i.e. lower) surface of the substrate; a transparent pattern paint layer painted on a rear surface of the primer layer, a surface of the transparent pattern paint layer being dried with hot air in an oven such that a pattern is formed; a deposition layer deposited on a rear surface of the transparent pattern paint layer; a finishing layer painted on a rear surface of the deposition layer; and a clear coating layer painted on a front (i.e. upper) surface of the substrate.

In accordance with another exemplary aspect of the present invention, there is provided a method of manufacturing an injection preform having a pattern on a surface thereof, the method preferably including the steps of: (1) forming a transparent or semi-transparent substrate by injection molding; (2) painting a primer layer on a rear surface of the substrate after step (1); (3) painting a transparent pattern paint layer for forming a pattern on a surface thereof through hot air drying in an oven on a rear surface of the primer layer after step (2); (4) depositing a deposition layer on a rear surface of the transparent pattern paint layer after step (3); (5) painting a finishing layer on a rear surface of the deposition layer after step (4); and (6) painting a clear coating layer on a front surface of the substrate after step (5).

### BRIEF DESCRIPTION OF THE DRAWINGS

The above and other exemplary aspects, features and advantages of the present invention will become more apparent to a person of ordinary skill in the art from the following detailed description taken in conjunction with the accompanying drawings, in which:

FIG. 1 is a view illustrating an appearance of a conventional plastic molded product;

FIG. 2 is a view illustrating an injection preform having a pattern on a surface thereof according to an exemplary embodiment of the present invention;

FIG. 3 is a view illustrating an injection preform having a pattern on a surface thereof according to another exemplary embodiment of the present invention; and

FIG. 4 is a flowchart illustrating exemplary operation of a method of manufacturing an injection preform having a pattern on a surface thereof according to an exemplary embodiment of the present invention.

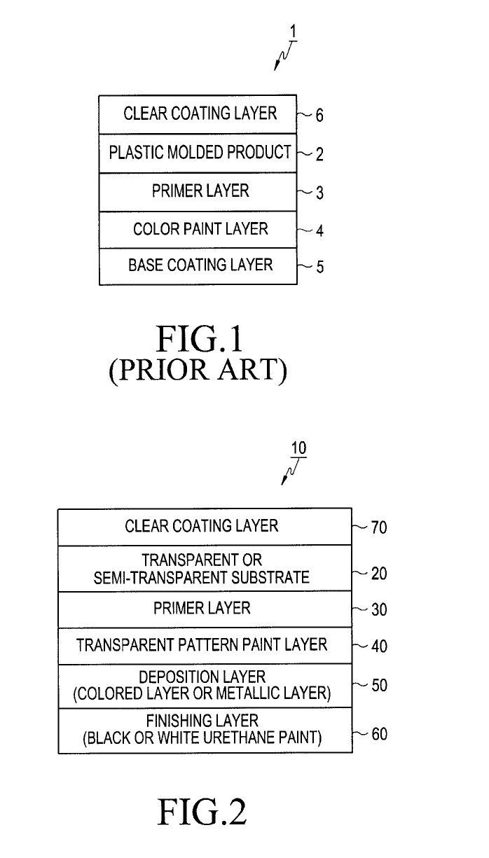

### DETAILED DESCRIPTION

Hereinafter, exemplary embodiments of the present invention will be described in detail with reference to the accompanying drawings. A person of ordinary skill in the art should understand that the configurations described herein and illustrated in the drawings are merely the embodiments of the present invention and may be replaced by various modifications as of the time when the application is filed. A person of ordinary skill in the art should understand and appreciate that with regard to the layers, a rear surface typically refers to a lower surface of a layer, and a op surface refers to an upper surface of the layer. The term “arranged on” may or may not be in direct contact with preceding or subsequent layers.

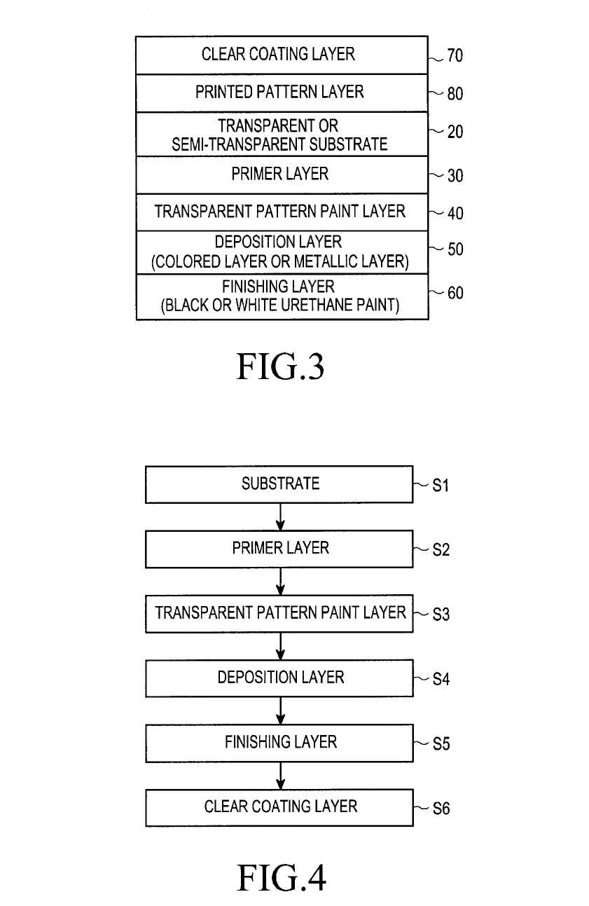

As illustrated in FIGS. 2 and 3, an injection preform 10 having a pattern on a surface thereof preferably includes an injection molded transparent or semi-transparent substrate 20, a primer layer 30, a transparent pattern paint layer, a deposition layer 50, a finishing layer 60, and a clear coating layer 70. The substrate 20 is in contact with the primer layer 30 to be described below, and the primer layer 30 is painted on a rear surface of the substrate so as to in contact with the substrate 20 and the transparent pattern paint layer 40 to be described below. The transparent pattern paint layer 40 is arranged on a rear (lower) surface of the primer layer 30 and is dried with hot air, preferably in an oven, in order to form a crack pattern, and the deposition layer 50 is deposited on a rear surface of the transparent pattern paint layer 40 to create various colors and metallic feelings. The finishing layer 50 is arranged on a rear surface of the deposition layer 50 to shield the deposition layer 50, and the clear coating layer 70 is coated on a front surface of the substrate 20 to protect a surface of the substrate 20.

According to the preform shown in FIG. 2, the primer layer 30 is transparent, and is preferably formed of an acryl polyol resin so as to be in contact with the substrate and the transparent pattern paint layer 40, but may also be formed of another resin other than an acryl polyol resin. (For example, an epoxy resin etc.)

The transparent pattern paint layer 40 can be formed of an acryl polyol resin, a melamine resin, an epoxy resin, amine, an acid catalyst, and salt, but may also be formed of another resin other than an acryl polyol resin, a melamine resin, an epoxy resin, amine, an acid catalyst, and salt.

The deposition layer 50 a colored layer or a metallic layer.

The colored layer is preferably formed of a polyolefin resin and has a white color, but may also have another color other than a white color. (For example, blue, red, green, etc.).

The metallic layer is preferably formed of any one of silver, tin, aluminum, and stainless steel, but may also be formed of another metal other than silver, tin, aluminum, and stainless steel. (For example, nickel, chrome, etc.)

The finishing layer 60 is preferably formed of any one of black, white, and silver urethane paints, but may also be formed of another paint other than black, white, and silver urethane paints. (For example, grey, blue, etc.)

The hot air drying is performed preferably at a temperature of 90 to 120 degrees Celsius at a duration of 30 to 120 minutes. When the pattern of the transparent pattern paint layer 40 is relatively large, the hot air drying is performed at a temperature of 90 to 110 degrees Celsius, and when the pattern of the transparent pattern paint layer 40 is relatively small, the hot air drying is performed at a temperature of 110 to 120 degrees Celsius. The present invention is to realize a crack pattern (e.g. a brick pattern) in a substrate by making a pattern area of a transparent pattern paint layer large or small then the initial pattern area.

That is, making a pattern of a transparent pattern paint layer large or small means making a pattern area large or small. In other words, first, a pattern area of the transparent pattern paint layer is formed by a temperature (90° C.-120° C.) and a duration (30-120 minutes) of hot-air-drying and when a pattern area is larger or smaller than the initial pattern area formed by the temperature and duration, a temperature of hot-air-drying is 90° C.-110° C. and 110° C.-120° C., respectively.

The substrate 20 is dried at a temperature of substantially 80 degrees Celsius after the finishing layer 60 is painted, and the drying time of the substrate 20 is substantially 180 minutes.

FIG. 3 illustrates another exemplary embodiment of an injection preform 10. In this example, a printed pattern layer 80 is painted in order to form various patterns other than the crack pattern between the clear coating layer 70 and the substrate 20.

The injection preforms 10, each of which have a pattern on a surface thereof according to exemplary embodiments of the present invention may be utilized to a portable communication device (not shown) as an example, would could constitute a case or housing of an electronic device. However, the injection preforms as constructed according to the present invention are not limited to a portable communication device, but the injection preforms may also be utilized in all products that can be injection molded. (For example, a cosmetic case, an information communication device, a case or window for an electronic device, a vehicle, electronic equipment, etc.)

Some types of non-limiting examples of portable communication devices according to the exemplary embodiments of the present invention shown and described herein preferably includes all mobile communication terminals that operate based on communication protocols corresponding to various communication systems, all information and communication devices such as a portable multimedia player (PMP), an MP3 player, a navigation system, a gaming device, a laptop computer, a tablet computer, a notebook computer, an advertising panel, a TV, a digital broadcasting player, a personal digital assistant (PDA), a smart phone, electronic devices and multimedia devices, and application devices thereof.

Hereinafter, the operations of an injection preform having a pattern on a surface thereof according to an exemplary embodiment of the present invention will be described in more detail with reference to FIGS. 2 and 3.

As illustrated in FIG. 2, in order to manufacture an injection preform 10 having a pattern on a surface thereof, a transparent or semi-transparent substrate 20 is formed first by injection molding.

Next, a primer layer 30 is painted on a rear surface of the substrate 20 to be in contact with the substrate 20 and a transparent pattern paint layer 40.

Here, the primer layer 30 is transparent and is formed of an acryl polyol resin.

Next, a transparent pattern paint layer 40 for forming a crack pattern is painted on a rear surface of the primer layer 30 and is dried preferably by hot air in an oven.

Then, the transparent pattern paint layer 40 is formed of an acryl polyol resin, a melamine resin, an epoxy resin, an acid catalyst, and amine, and a crack pattern is produced due to contraction of the transparent pattern paint layer 40 caused by a difference in drying and hardening speeds between an upper portion and a lower portion of the transparent pattern paint layer 40 after the transparent pattern paint layer 40 is painted on the rear surface of the primer layer 30.

An acid catalyst for expediting hardening of an acryl resin and a melamine resin and amine for producing salt so that the acid catalyst cannot react during storage of the transparent pattern paint layer 40 are added to the transparent pattern paint layer 40.

While amine on a surface layer comprising a salt (salt is produced in paint due to a reaction of an acid catalyst and amine) is being vaporized by hot air drying after the transparent pattern paint layer 40 is painted, the acid catalyst left on the surface of the transparent pattern paint layer 40 expedites a reaction of an acryl resin and a melamine resin, hardening the surface of the transparent pattern paint layer 40.

The transparent pattern paint layer 40 is contracted and cracked due to the volatilizing and drying speed of the acid catalyst and amine, forming a combed pattern.

A top layer portion of the transparent pattern paint layer 40 is severely contracted, and a bottom layer portion of the transparent pattern paint layer 40 is slightly contracted. The transparent pattern paint layer 40 is cracked to form such a pattern using such stresses.

Then, the used amine reacts rapidly, causing no problem to its storage.

When a surface of the transparent pattern paint layer 40 has hardened, the interior of the transparent pattern paint layer 40 to which heat is transferred slowly is not dried with hot air, causing fluidity, and the fluidity of the interior of the transparent pattern paint layer 40 forms a crack pattern on the surface of the transparent pattern paint layer 40.

Then, the wax component in the transparent pattern paint layer 40 changes into a core particle state, forming a uniform crack pattern around the pattern.

After the transparent pattern paint layer 40 is painted, hot air drying is performed in an oven at a temperature of substantially 90 to 120 degrees Celsius and for about 30 to 120 minutes.

Here, when a pattern of the transparent pattern paint layer 40 is relatively large, hot air drying is performed at a temperature of 90 to 110 degrees Celsius.

When a pattern of the transparent pattern paint layer 40 is relatively small, hot air drying is performed at a temperature of 110 to 120 degrees Celsius.

As time elapses, all the amine left in the transparent pattern paint layer 40 is vaporized, hardening the interior of the transparent pattern paint layer 40.

Next, a deposition layer 50 is deposited on a rear surface of the transparent pattern paint layer 40.

The deposition layer 50 may comprise a colored layer or a metallic layer. The colored layer is formed of a polyolefin resin and has various colors or a white color using a polyolefin resin. The metallic layer is formed of any one of silver, tin, aluminum, and stainless steel.

Next, a finishing layer 60 for shielding the interior of the substrate 20 is painted on a rear surface of the deposition layer 50.

The finishing layer 60 is formed of any one of black, white, and silver urethane paints.

After the finishing layer 60 is painted, the substrate 20 is dried at substantially 80 degrees Celsius and for a duration of a substantially 180 minutes.

Next, a clear coating layer 70 is painted on a front surface of the substrate 20 in order to protect an outer surface of the substrate 20.

FIG. 3 illustrates another exemplary embodiment of the injection preform 10, a printed pattern layer 80 is painted between the clear coating layer 70 and the substrate 20 to form various luxurious and new patterns in addition to the crack pattern.

The detailed steps of the method of manufacturing an injection preform having a pattern on a surface thereof according to this exemplary embodiment of the present invention will now be described with reference to FIG. 4.

As illustrated in FIG. 4, in the method of manufacturing an injection preform 10 having a pattern on a surface thereof, a transparent or semi-transparent substrate 20 is first formed by injection molding (S1).

A primer layer 30 is painted on a rear surface of the substrate 20 so as to be in contact with the substrate 20 and the transparent pattern paint layer 40 (S2). In this example, the primer layer 30 is preferably transparent, and is comprised of an acryl polyol resin.

After step S2, a transparent pattern paint layer 40 for forming a crack pattern after being dried by hot air in an oven is painted on a rear surface of the primer layer 30 (S3)

The transparent pattern paint layer 40 is formed of an acryl polyol resin, a melamine resin, an epoxy resin, an acid catalyst, and amine. A crack pattern is produced due to contraction of the transparent pattern paint layer 40 caused by a difference in drying and hardening speeds between an upper portion and a lower portion of the transparent pattern paint layer 40 after the transparent pattern paint layer 40 is painted.

An acid catalyst for expediting hardening of an acryl resin and a melamine resin and amine for producing salt so that the acid catalyst cannot react during storage of the transparent pattern paint layer 40 are added to the transparent pattern paint layer 40 as described above.

While amine on a surface layer comprises salt (salt is produced in paint due to a reaction of an acid catalyst and amine) is being vaporized by hot air drying after the transparent pattern paint layer 40 is painted, the acid catalyst left on the surface of the transparent pattern paint layer 40 expedites a reaction of an acryl resin and a melamine resin, hardening the surface of the transparent pattern paint layer 40.

The transparent pattern paint layer 40 is contracted and cracked due to the volatilizing and drying speed of the acid catalyst and amine, thereby forming a combed pattern.

A top layer portion of the transparent pattern paint layer 40 is severely contracted, and a bottom layer portion of the transparent pattern paint layer 40 is slightly contracted. The transparent pattern paint layer 40 is cracked to form such a pattern using such different stresses.

Then, the used amine reacts rapidly, causing no problem to its storage.

When a surface of the transparent pattern paint layer 40 is hardened, the interior of the transparent pattern paint layer 40 to which heat is transferred slowly is not dried with hot air, causing fluidity, and the fluidity of the interior of the transparent pattern paint layer 40 forms a crack pattern on the surface of the transparent pattern paint layer 40.

Then, the wax component in the transparent pattern paint layer 40 changes into a core particle state, forming a uniform crack pattern around the pattern.

After the transparent pattern paint layer 40 is painted, hot air drying is performed, preferably in an oven (not shown) at a temperature of about 90 to 120 degrees Celsius and for a duration of on order of 30 to 120 minutes.

Here, when a pattern of the transparent pattern paint layer 40 is relatively large, hot air drying is performed at a temperature on order of 90 to 110 degrees Celsius.

When a pattern of the transparent pattern paint layer 40 is relatively small, hot air drying is performed at a temperature on order of 110 to 120 degrees Celsius.

As time elapses, all the amine left in the transparent pattern paint layer 40 is vaporized, hardening the interior of the transparent pattern paint layer 40.

After step S3, a deposition layer 50 is deposited on a rear surface of the transparent pattern paint layer 40 (S4).

The deposition layer 50 comprises a least one of a colored layer or a metallic layer. The colored layer is formed of a polyolefin resin and has various colors or a white color using a polyolefin resin. The metallic layer is formed of any one of silver, tin, aluminum, and stainless steel.

After step S4, a finishing layer 60 for shielding the interior of the substrate 20 is painted on a rear surface of the deposition layer 50 (S5).

The finishing layer 60 is formed preferably of any one of black, white, and silver urethane paints.

After the finishing layer 60 is painted, the substrate 20 is dried at substantially 80 degrees Celsius and for on order of 180 minutes.

After step S5, a clear coating layer 70 is painted on a front surface of the substrate 20 to protect an outer surface of the substrate 20 (S6).

As described above, according to the present invention, a transparent pattern paint layer 40 is manufactured to form a crack pattern in a transparent or semi-transparent substrate 20, realizing patterns (for example, rough patterns, block patterns, etc.) for ceramics, marbles, and exterior building materials and making designs of products appealing.

As person of ordinary skill in the art should understand and appreciate that while the exemplary embodiments disclose certain layers that are in contact with other layers, it is within the spirit and scope of the claimed invention that the layers could be stacked on each other with other layers intervening there between. Also, the term “substantially can refer to more or less than an indicated temperature or time value.

While the invention has been shown and described with reference to certain exemplary embodiments thereof, it will be understood by those skilled in the art that the invention is not limited to those embodiments and the accompanying drawings but various substitutions, changes, and modifications may be made therein without departing from the spirit and scope of the invention as defined by the appended claims.

What is claimed is:

1. An injection preform having a pattern on a surface thereof, the injection preform comprising:
a transparent or semi-transparent injection molded substrate;
a primer layer arranged on a lower surface of the substrate;
a transparent pattern paint layer arranged on a lower surface of the primer layer, a surface of the transparent pattern paint layer being dried with hot air such that a pattern is formed;
a deposition layer deposited on a lower surface of the transparent pattern paint layer;
a finishing layer arranged on a lower surface of the deposition layer; and
a clear coating layer arranged on an upper surface of the substrate.

2. The injection preform as claimed in claim 1, wherein the primer layer is formed of an acryl polyol resin.

3. The injection preform as claimed in claim 1, wherein the transparent pattern paint layer is formed of an acryl polyol resin, a melamine resin, an epoxy resin, amine, an acid catalyst, and salt.

4. The injection preform as claimed in claim 1, wherein the deposition layer comprises a colored layer or a metallic layer.

5. The injection preform as claimed in claim 4, wherein the colored layer is comprised of a polyolefin resin and has a white color.

6. The injection preform as claimed in claim 4, wherein the metallic layer is comprised of one of silver, tin, aluminum, and stainless steel.

7. The injection preform as claimed in claim 1, wherein the finishing layer is comprised of one of black, white, and silver urethane paints.

8. The injection preform as claimed in claim 1, wherein a printed pattern layer is arranged between the clear coating layer and the substrate.

9. The injection preform as claimed in claim 1, wherein the surface of the transparent pattern paint layer is dried at a temperature ranging from substantially 90 to 120 degrees Celsius and for a duration of substantially 30 to 120 minutes, and wherein when a pattern of the transparent pattern paint layer is larger than the initial pattern area, the surface of the transparent pattern paint layer is dried with hot air at a temperature of 90 to 110 degrees Celsius, and when a pattern of the transparent pattern paint layer is smaller than the initial pattern area, the surface of the transparent pattern paint layer is dried with hot air at a temperature of 110 to 120 degrees Celsius.

10. The injection preform as claimed in claim 1, wherein after the finishing layer is arranged on the deposition layer, the substrate is dried at substantially 80 degrees Celsius and for a duration of substantially 180 minutes.

11. A method of manufacturing an injection preform having a pattern on a surface thereof, the method comprising the steps of:
(1) forming a transparent or semi-transparent substrate by injection molding;
(2) painting a primer layer on a lower surface of the substrate;
(3) painting a transparent pattern paint layer for forming a pattern on a surface of the primer layer after hot air drying the primer layer painted on the lower surface substrate;
(4) depositing a deposition layer on a lower surface of the transparent pattern paint layer;
(5) painting a finishing layer on a lower surface of the deposition layer; and
(6) painting a clear coating layer on an upper surface of the substrate.

12. The method as claimed in claim 11, wherein in the step (2), the primer layer is comprised of an acryl polyol resin.

13. The method as claimed in claim 11, wherein in the step (3), the transparent pattern paint layer is comprised of an acryl polyol resin, a melamine resin, an epoxy resin, an amine, an acid catalyst, and salt.

14. The method as claimed in claim 11, wherein in the step (4), the deposition layer comprises a colored layer or a metallic layer.

15. The method as claimed in claim 14, wherein the colored layer is comprised of a polyolefin resin and has a white color.

16. The method as claimed in claim 14, wherein the metallic layer is comprised of one of silver, tin, aluminum, and stainless steel.

17. The method as claimed in claim 11, wherein in step (5), the finishing layer is comprised of one of black, white, and silver urethane paints.

18. The method as claimed in claim 11, wherein in step (6), a printed pattern layer is comprised between the clear coating layer and the substrate.

19. The method as claimed in claim 11, wherein in step (3), the surface of the transparent pattern paint layer is dried with hot air at a temperature ranging from 90 to 120 degrees Celsius and for a duration ranging from 30 to 120 minutes, and wherein when a pattern of the transparent pattern paint layer is larger than the initial pattern area, the surface of the transparent pattern paint layer is dried with hot air at a temperature of 90 to 110 degrees Celsius, and when a pattern of the transparent pattern paint layer is smaller than the initial pattern area, the surface of the transparent pattern paint layer is dried with hot air at a temperature of 110 to 120 degrees Celsius.

20. The method as claimed in claim 11, wherein the step (5), after the finishing layer is painted on the deposition layer, the substrate is dried at substantially 80 degrees Celsius and for a duration of substantially 180 minutes.
